(19) United States
(12) Patent Application Publication
(10) Pub. No.: US 2015/0294649 A1
(43) Pub. Date: Oct. 15, 2015

(54) DISPLAY CONTROL APPARATUS, DISPLAY CONTROL PROGRAM AND DISPLAY CONTROL METHOD

(71) Applicant: KYOCERA Corporation, Kyoto-shi, Kyoto (JP)

(72) Inventor: Hitoshi Imamura, Nishinomiya-shi (JP)

(21) Appl. No.: 14/438,609

(22) PCT Filed: Oct. 24, 2013
(86) PCT No.: PCT/JP2013/078754

§ 371 Date: Apr. 24, 2015

Related U.S. Application Data
(63) Continuation of application No. PCT/JP2013/078754, filed on Oct. 24, 2013.

(30) Foreign Application Priority Data
Oct. 25, 2012 (JP) 2012-235268

(51) Int. Cl. G09G 5/377; G06F 3/0484; G06F 3/041; G06F 3/0488; G09G 5/36

(52) U.S. Cl. CPC G09G 5/377; G06F 3/04883; G09G 5/36; G06F 3/0412; G06F 3/04847; G06F 3/04845

(57) ABSTRACT

A display control apparatus (10) sets (S17, S21) a prohibition area (PA) to a display surface in displaying an object image (Ob) on a display surface (30a) to be arranged on a background image (Wp), moves (S23) the object image located in an inside of the prohibition area being set to an outside of the prohibition area, and displays (S25) on the display surface a screen (DT) that the object image after moved is arranged on the background image. Accordingly, an object can be displayed while avoiding a desired portion.

### FIELD OF ART

The present invention relates to a display control apparatus, a display control program and a display control method, more specifically, a display control apparatus, a display control program and a display control method, which displays an object image such as an icon, widget etc. by arranging the object image on a background image such as a portrait photograph.

### BACKGROUND ART

The following is known as such a kind of conventional apparatus. In this background art, an area demarcated by a color that occupancy is high in a standby image is determined as a displayable area, and the standby image into which a widget is incorporated is displayed in the displayable area being determined. On a case where the standby image is a portrait photograph, for example, since various colors are often intermingled complicatedly into a person portion, a possibility that the person portion is selected as the displayable area becomes low, and as a result, the widget becomes easy to be arranged while avoiding the person portion.

### SUMMARY OF THE INVENTION

### Problems to be Solved by the Invention

However, in the above-described background art, a widget only becomes easy to be arranged in an area that is demarcated by a color that the occupancy is high, that is, an area that color change is few, and may not be necessarily displayed while avoiding a desired portion. In a case of a photograph image that a face of a person who is present in a flower garden is photographed, for example, if flowers of various colors are intermingled complicatedly around the face of a skin color, a portion of the face may be selected as the displayable area and thus a widget may be arranged in the portion of the face.

Therefore, it is a primary object of the present invention to provide a novel display control apparatus, display control program and display control method.

It is another object of the present invention to provide a display control apparatus, display control program and display control method, capable of displaying an object with avoiding a desired portion.

### Means for Solving a Problem

A first manner of the invention is a display control apparatus that displays an object image on a display surface to be arranged on a background image, comprising: a setting module operable to set a prohibition area in the display surface; a first moving module operable to move the object image located in an inside of the prohibition area that is set by the setting module to an outside of the prohibition area; and a control module operable to display on the display surface a screen that the object image after moved by the first moving module is arranged on the background image.

A second manner of the invention is a display control program that causes a CPU of a display control apparatus that displays an object image on a display surface to be arranged on a background image to function as: a setting module operable to set a prohibition area in the display surface; a first moving module operable to move the object image located in an inside of the prohibition area that is set by the setting module to an outside of the prohibition area; and a control module operable to display on the display surface a screen that the object image after moved by the first moving module is arranged on the background image.

A third manner of the invention is a display control method in a display control apparatus that displays an object image on a display surface to be arranged on a background image, comprising steps of: a setting step setting a prohibition area in the display surface; a first moving step moving the object image located in an inside of the prohibition area that is set by the setting step to an outside of the prohibition area; and a control step displaying on the display surface a screen that the object image after moved by the first moving step is arranged on the background image.

### Advantage of the Invention

According to the present invention, it is possible to implement a display control apparatus, display control program and display control method, capable of displaying an object with avoiding a desired portion.

The above described objects and other objects, features, aspects and advantages of the invention will become more apparent from the following detailed description of the invention when taken in conjunction with the accompanying drawings.

### BRIEF DESCRIPTION OF THE DRAWINGS

[FIG. 1]

FIG. 1 is a block diagram showing structure of a portable terminal that is an embodiment of the present invention.

[FIG. 2]

FIG. 2 is an illustration view showing a display surface of a display (touch device) that a touch panel is provided, and an prohibition area that is set in the display surface by a slide operation (inside of a rectangle defined by a start point and an end point of the slide operation).

[FIG. 3]

FIG. 3 shows a display example of a case where no prohibition area is set, wherein FIG. 3(A) shows a screen for selecting whether a prohibition area is to be set and FIG. 3(B) shows a desktop (DT) screen that the prohibition area is not set.

[FIG. 4]

FIG. 4 shows a display example of a case where a prohibition area is to be set, wherein FIG. 4(A) shows a screen for selecting whether the prohibition area is to be set manually, FIG. 4(B) shows a screen that the prohibition area is set by a slide operation, FIG. 4(C) shows a screen for confirming the prohibition area being set, and FIG. 4(D) shows a desktop screen that the prohibition area is set.

[FIG. 5]

FIG. 5 shows a display example of a case where a prohibition area is to be set automatically (face recognition), wherein FIG. 5(A) shows a screen for selecting whether the prohibition area is to be set automatically (face recognition) and FIG. 5(B) shows a desktop screen that the prohibition area is set.

[FIG. 6]

FIG. 6 shows a display example of a case where objects cannot be fully displayed on the desktop screen that the prohibition area is set, wherein FIG. 6(A) shows the desktop screen filled with objects and FIG. 6(B) shows a further desktop screen that displays an object that cannot be displayed on the desktop screen.

[FIG. 7]

FIG. 7 is an illustration view showing a manner of warning by displaying the prohibition area when an object enters into the prohibition area in a case where the object is manually moved in the desktop screen that the prohibition area is set.

[FIG. 8]

FIG. 8 is an illustration view showing a manner of displaying a further desktop screen when an object reaches a left or right end portion in a case where the object is manually moved in the desktop screen the prohibition area is set.

[FIG. 9]

FIG. 9 is a memory map showing contents of a main memory.

[FIG. 10]

FIG. 10 is an illustration view showing an example of object arrangement information stored in the main memory, and corresponds to FIG. 6.

[FIG. 11]

FIG. 11 is a flowchart showing setting processing by a CPU.

[FIG. 12]

FIG. 12 is a flowchart showing details of object automatically moving processing included in the setting processing.

[FIG. 13]

FIG. 13 is a flowchart showing DT control processing following the setting processing.

[FIG. 14]

FIG. 14 shows a modified example of setting a prohibition area by a slide operation, wherein FIG. 14(A) shows a case where an inside of a circle or ellipse that are defined by a start point and an end point of the slide operation is set as the prohibition area and FIG. 14(B) shows is a case where a range surrounded by a locus of the slide operation is set as the prohibition area.

[FIG. 15]

FIG. 15 is an illustration view showing a setting example of a prohibition area by a template.

### FORMS FOR EMBODYING THE INVENTION

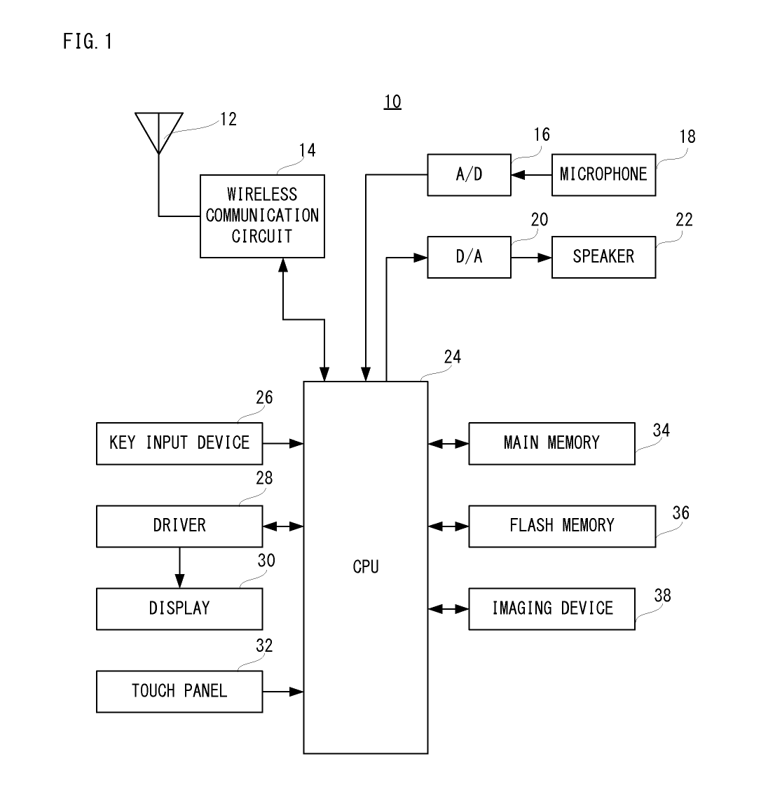

Hardware structure of a portable terminal 10 is shown in FIG. 1. With reference to FIG. 1, the portable terminal 10 that is an embodiment of a present invention includes a CPU 24. The CPU 24 is connected with a key input device 26, a touch panel 32, a main memory 34, a flash memory 36 and an imaging device 38, and further with an antenna 12 via a wireless communication circuit 14, a microphone 18 via an ND converter 16, a speaker 22 via a D/A converter 20, and a display 30 via a driver 28.

The antenna 12 receives a radio wave signal from a base station not shown. Furthermore, the antenna 12 transmits a radio wave signal from the wireless communication circuit 14. The wireless communication circuit 14 demodulates and decodes the radio wave signal received by the antenna 12, and encodes and modulates a signal from the CPU 24. The microphone 18 converts a sound wave into an analog voice signal, and the ND converter 16 converts a voice signal from the microphone 18 into digital voice data. The D/A converter 20 converts the voice data from the CPU 24 into an analog voice signal, and the speaker 22 converts the voice signal from the D/A converter 20 into a sound wave.

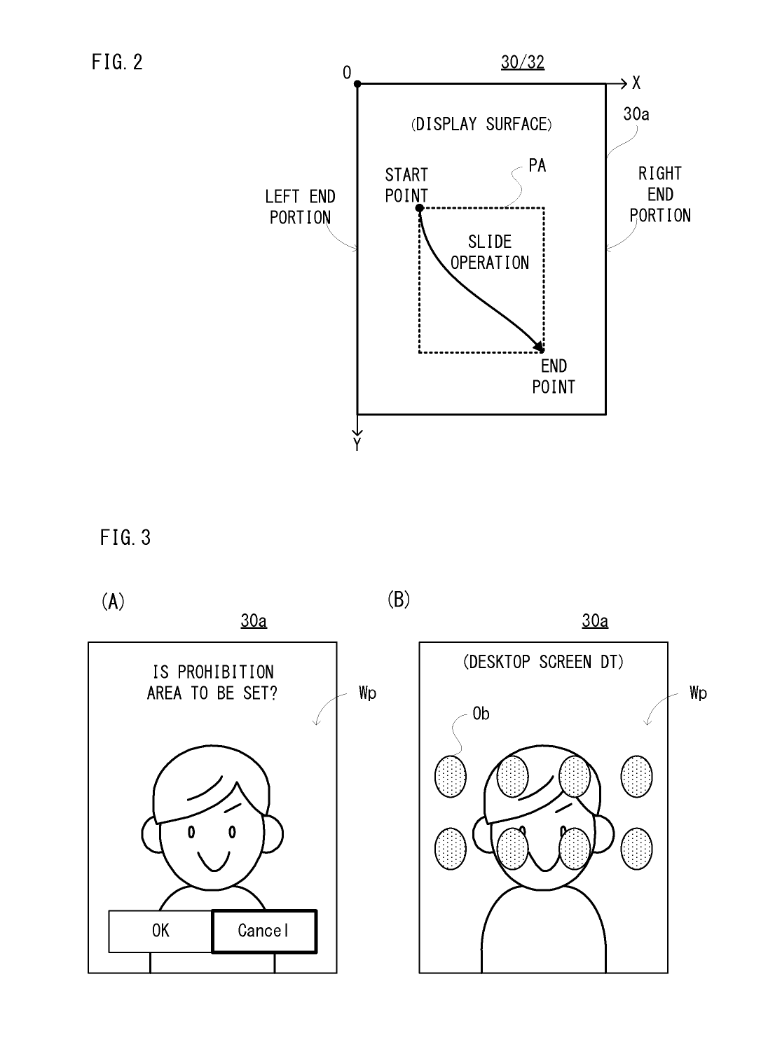

The key input device 26 is constituted by various kinds of keys, buttons (not shown), etc. operated by a user (operator), and inputs a signal (command) corresponding to an operation into the CPU 24. The driver 28 displays an image corresponding to a signal from the CPU 24 on the display 30. The touch panel 32 is provided on the display surface 30a of the display 30, and inputs into the CPU 24 a signal (X, Y coordinates: see FIG. 2) indicating a position of a touch point.

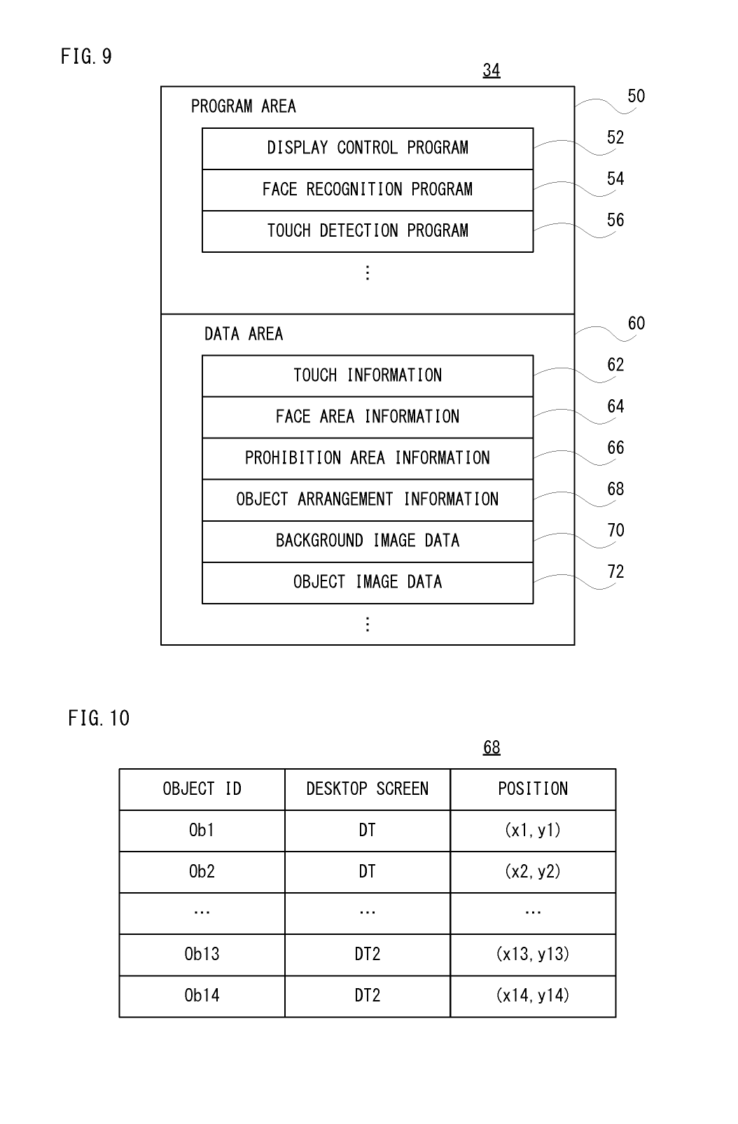

The main memory 34 is constituted by an SDRAM, etc., for example, and stored with programs for making CPU 24 perform various kinds of processing, data, etc. (see FIG. 9), and provides a working area required for the CPU 24. The flash memory 36 is constituted by a NAND type flash memory, for example, and is utilized as a saving area of the program or a recording area of image data by the imaging device 38.

The imaging device 38 is constituted by a lens, an image sensor (imaging element such as a CCD and a CMOS), a camera processing circuit, etc. (all not shown), and photoelectric-converts an optical image that is focused on the image sensor via the lens to output image data corresponding to the optical image.

The CPU 24 performs various kinds of processing according to programs (52-56) stored in the main memory 34 while utilizing other hardware (12-22, 26-38).

In the portable terminal 10 constituted as described above, it is possible to select, through a desktop screen as shown FIG. 3(B), for example, a telephone application for performing a telephone calling, a camera application for performing photographing with a camera, etc. In the desktop screen DT, various kinds of object images (an icon and a widget) Ob related to the telephone application or the camera application are arranged on the background image (wallpaper such as a portrait photograph) Wp, and by performing a touch operation to any one of the objects Ob, a desired mode can be selected.

If the telephone application is selected, the portable terminal 10 displays a screen for performing a telephone calling on the display 30. In detail, if a calling operation is performed through the key input device 26, the CPU 24 controls the wireless communication circuit 14 to output a calling signal. The calling signal that is output is transmitted via the antenna 12 to be transferred to a telephone at the other end of line through a mobile communication network not shown. The telephone at the other end of line starts a call by a ringer tone, etc. If a person who receives an incoming call performs a receiving operation to the telephone at the other end of line, the CPU 24 starts telephone conversation processing. On the other hand, if a calling signal from a telephone at the other end of line is captured by the antenna 12, the wireless communication circuit 14 notifies an incoming call to the CPU 24, and the CPU 24 starts a call by a ringer tone from the speaker 22, vibration of a vibrator not shown, etc. If a receiving operation is performed by the key input device 26, the CPU 24 starts telephone conversation processing.

The telephone conversation processing is performed as follows, for example. A receiving voice signal sent by the telephone at the other end of line is captured by the antenna 12 and applied to the speaker 22 through D/A converter 20 after subjected to demodulation and decode by the wireless communication circuit 14. Accordingly, a receiving voice is output from the speaker 22. On the other hand, a sending voice signal taken in by the microphone 18 is sent to the wireless communication circuit 14 through the ND converter 16, and is transmitted to the telephone at the other end of line through the antenna 12 after subjected to encode and modulation by the wireless communication circuit 14. Also in the telephone at the other end of line, demodulation and decode of the sending voice signal are performed to output a sending voice.

If the camera application is selected, the portable terminal 10 enables a camera. In detail, the CPU 24 issues a through photography start instruction, and therefore, the imaging device 38 starts a through photographing. In the imaging device 38, the optical image that is focused to the image sensor through the lens not shown is subjected to photoelectric conversion, whereby an electric charge representing the optical image can be produced. In the through photographing, a part of the electric charge produced by the image sensor is read as a raw image signal with low resolution at every 1/60 seconds, for example. The raw image signal that is read is converted into the image data of YUV form by receiving a series of image processing such as A/D conversion, color separation and YUV conversion by the camera processing circuit. The image data with low resolution for a through display is thus output from the imaging device 38 with a frame rate of 60 fps, for example. The image data that is output is written in the main memory 34 as through image data at present, and the driver 28 reads the through image data stored in the main memory 34 repeatedly to display a through image based thereon on the display 30.

Then, if a user performs a shutter release operation with the key input device 26 or the touch panel 32 while displaying the through image, the CPU 24 issues a record instruction for recording a still picture. Accordingly, the electric charge produced by the image sensor is read as a raw image signal of high resolution for recording the still picture, and the raw image signal being read is converted into the image data of YUV form through a series of image processing by the camera processing circuit. The image data of high resolution is thus output from the imaging device 38, and the image data being output is written in the flash memory 36 as still picture data after saved temporarily in the main memory 34.

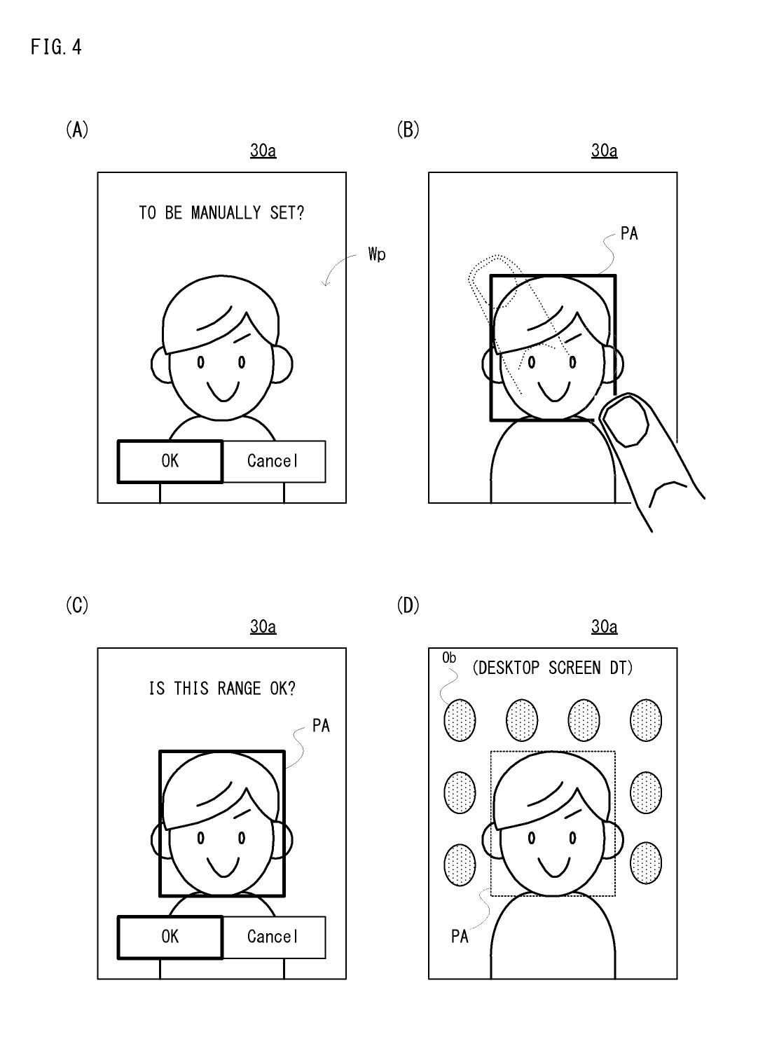

Incidentally, the user is not able to see a face image because the face image included in the background image Wp is hidden by the object image Ob in the desktop screen DT in FIG. 3(B) mentioned previously. Accordingly, in this embodiment, a prohibition area PA is set in a display surface 30a of the display 30 using a slide operation as shown in FIG. 2 or automatically using a face recognition, and the object image Ob is displayed in a portion excluding the prohibition area of the display surface 30a (see FIG. 4(B) and FIG. 4(D)).

In detail, as shown in FIG. 2, for example, in the display surface 30a, an X-axis and a Y-axis are defined rightward and downward by making an upper left end as an origin point O. If a touch operation (may be called a tap operation or a click operation) is performed to such a display surface 30a, a touch position (X, Y coordinates) is detected by the touch panel 32. Furthermore, if a slide operation is performed, a touch locus (for example, a group of coordinates of a sequence of points that constitute a touch locus) from a start point to an end point is detected by the touch panel 32.

Based on such a detection result of the touch panel 32, the CPU 24 can perform processing corresponding to the object (an icon, a widget, etc.) that is selected by a touch operation or can set an inside of a rectangle defined by the start point and the end point of the slide operation (for example, a square or rectangle that a diagonal line is made by the start point and the end point) as the prohibition area PA.

Specifically, the prohibition area PA is set through a screen as shown in FIG. 3 to FIG. 5. The background image Wp used as a wallpaper of the desktop screen DT is displayed on the screen. First, the user can select whether the prohibition area PA is to be set through a screen as shown in FIG. 3(A). Operating buttons such as “OK” and “Cancel” are displayed on the screen of FIG. 3(A) together with a dialog such as “Is prohibition area to be set?” If the user selects “Cancel” on the screen of FIG. 3(A), the desktop screen DT as shown in FIG. 3(B) is displayed without performing setting of the prohibition area PA. In a case of the desktop screen DT in FIG. 3(B), that is, the desktop screen that the prohibition area PA is not set, the object image Ob may be arranged in a center portion of the background image Wp, that is, on the face image.

If “OK” is selected on the screen of FIG. 3(A), a screen as shown in FIG. 4(A) is subsequently displayed, and the user can select whether the prohibition area PA is to be set manually. Operating buttons such as “OK” and “Cancel” are displayed on the screen of FIG. 4(A) together with a dialog such as “To be manually set?”, and the setting of the prohibition area PA by the slide operation shown in FIG. 2 is performed if the user selects “OK”. The prohibition area PA that changes (enlargement, reduction, deformation) corresponding to a touch position at present is specified through a screen as shown in FIG. 4(B) during the slide operation. In a case of this background image Wp, since a face image of a person exists in a center portion, the user designates the center portion of the display surface 30a as the prohibition area PA such that the face image is not hidden by the object image Ob.

If the prohibition area PA is thus designated based on the slide operation, a screen as shown in FIG. 4(C) is displayed, and the user can confirm whether the prohibition area PA that is designated is sufficient. Operating buttons such as “OK” and “Cancel” are displayed on the screen of FIG. 4(C) together with a dialog such as “Is this range OK?” If the user selects “OK” here, the desktop screen DT as shown in FIG. 4(D) becomes to be displayed. In a case of the desktop screen DT of FIG. 4(D), since the center portion of the display surface 30a is set as the prohibition area PA, the object image Ob is arranged to avoid the center portion of the display surface 30a (outside the prohibition area PA), and therefore, the face image is not hidden by the object image Ob.

In addition, if “Cancel” is selected on the screen of FIG. 4(C), the prohibition area PA that is set as described above is abandoned, and the screen returns to FIG. 4(A), whereby the user can do over again an operation similar to the above described operation.

In addition, in FIG. 4(C), a confirmation screen after the object is moved may be displayed such that the user can confirm how the object image Ob is moved after the setting of the prohibition area PA. The confirmation screen may be a screen that the object image Ob is arranged when the prohibition area PA is set in a main home screen.

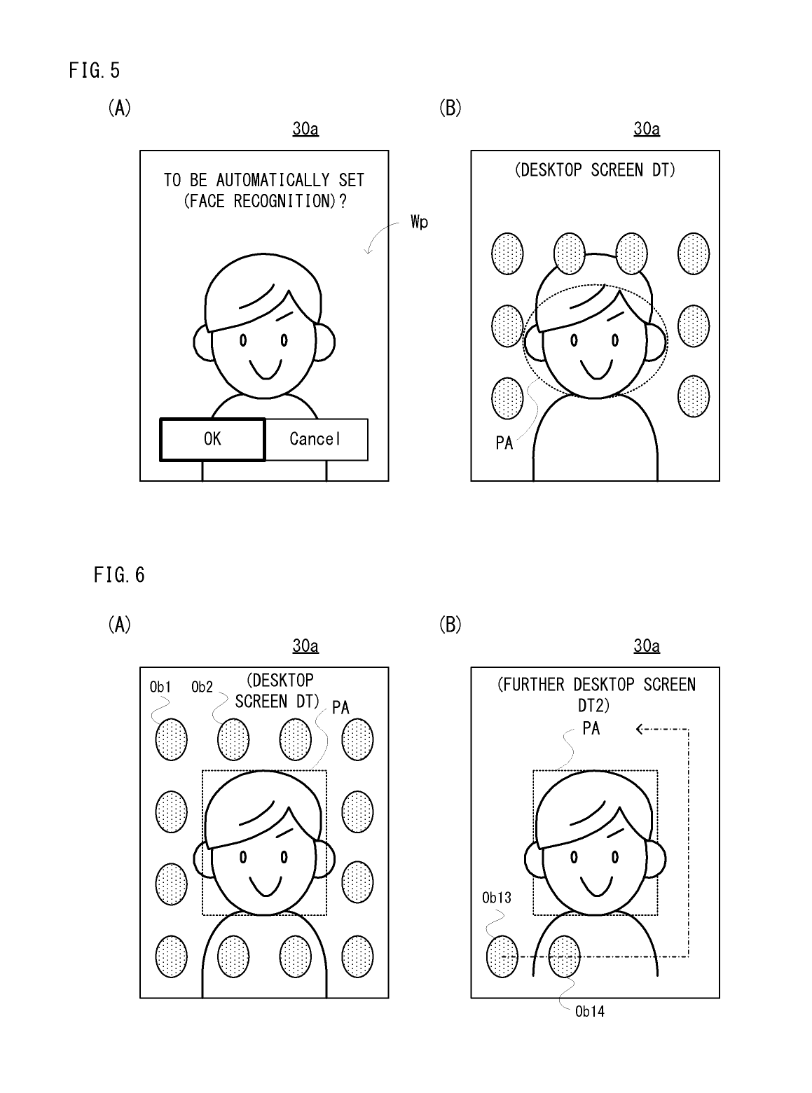

If “Cancel” is selected in the screen of FIG. 4(A), a screen as shown in FIG. 5(A) is subsequently displayed, whereby the user can select whether the prohibition area PA is to be automatically set (face recognition, for example). Operating buttons such as “OK” and “Cancel” are displayed on the screen of FIG. 5(A) together with a dialog such as “To be automatically set (face recognition)?”, and the face recognition is performed to the background image Wp if the user selects “OK”. Since the face image of the person exists in the center portion in a case of the background image Wp, the prohibition area PA is set to the center portion of the display surface 30a to surround this face image. In addition, instead of a range surrounding the face image, the face image itself may be set as the prohibition area PA.

If the prohibition area PA is thus set based on a result of the face recognition processing, the desktop screen DT as shown in FIG. 5(B) becomes to be displayed. In a case of the desktop screen DT that the range surrounding the face image of the desktop screen DT as shown in FIG. 5(B) is set as the prohibition area, since the object image Ob is arranged to avoid the prohibition area PA surrounding the face image, the face image is not hidden by the object image Ob.

In addition, if “Cancel” is selected on the screen of FIG. 5(A), the screen returns to FIG. 3(A), whereby the user can do over again an operation similar to the above described operation.

Thus, in the portable terminal 10, by setting the prohibition area to the display surface 30a manually or automatically, the object can be displayed while avoiding a desired portion (for example, face image included in the background image Wp).

However, there occurs a case where all the object images Ob cannot be arranged in the desktop screen DT because of setting the prohibition area PA to the display surface 30a. For example, in a case where there are fourteen (14) object images Ob1-Ob14 and only twelve (12) pieces out of them can be arranged in the desktop screen DT, as shown in FIG. 6(A), for example, the object images Ob1-Ob12 are arranged in the desktop screen DT, and remaining object images Ob13 and Ob14 are, as shown in FIG. 6(B), arranged on a further desktop screen DT2.

Since the prohibition area PA that is set in the display surface 30a is effective not only to the desktop screen DT but to the further desktop screen DT2, the object images Ob13 and Ob14 are arranged to avoid the prohibition area PA in the further desktop screen DT2 (outside the prohibition area PA). Specifically, a first object image Ob13 is arranged at the lower left of the further desktop screen DT2, and a second object image Ob14 is arranged on the right thereof.

If there are a third and subsequent object images Ob15, Ob16, Ob17, - - - , the third object image Ob15 is arranged on the right of the second object image Ob14, the fourth object image Ob16 is arranged on the right of the third object image Ob15, and then, supposing the display area of a lower end portion is filled with the display of the objects, the fifth object image Ob17 is arranged above the fourth object image Ob16. In other words, the objects are sequentially arranged at the lower left, at first, and to the right, then reaching a right end, from the lower right and to a top, then reaching an upper end, from the upper right to the left. That is, the objects are arranged to surround an outside of the prohibition area PA counterclockwise with the lower left as the starting point. However, the above-described order of arrangement is only an example, and an order of arrangement that the objects surround the outside of the prohibition area PA clockwise with the upper left as the starting point may be adopted, and furthermore, the objects may be arranged at random in a vacant portion outside the prohibition area PA.

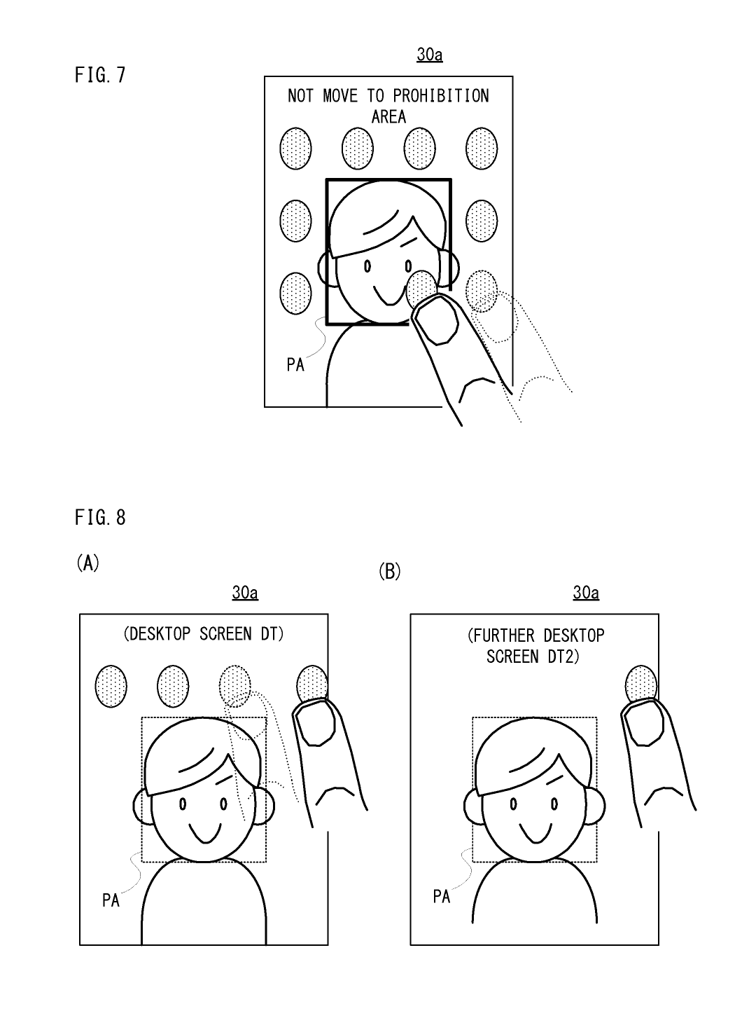

Furthermore, in a case where the prohibition area PA is set to the display surface 30a, if the object image Ob enters into the inside of the prohibition area PA during a time that the user moves by hand the object image Ob on the desktop screen DT or the further desktop screen DT2, that is, while dragging the object image Ob, warning is issued to the user by displaying the prohibition area PA together with a dialog such as “Not move to prohibition area” as shown in FIG. 7.

In addition, although illustration is omitted, if the object image Ob comes out of the outside of the prohibition area PA, the display of the dialog and the prohibition area PA is non-displayed. Furthermore, when the user releases the hand inside the prohibition area PA, that is, when the object image Ob is dropped within the inside of the prohibition area PA, the object image Ob is automatically moved to the outside of the prohibition area PA.

Furthermore, in a case where the prohibition area PA is set to the display surface 30a, if the object image Ob reaches a left end portion or right end portion of the display surface 30a as shown in FIG. 8(A) during a time that the user moves the object image Ob on the desktop screen DT by hand, as shown in FIG. 8(B), a further desktop screen DT2 becomes to be displayed, that is, the display content of the display surface 30a is updated with the further desktop screen DT2 from the desktop screen DT.

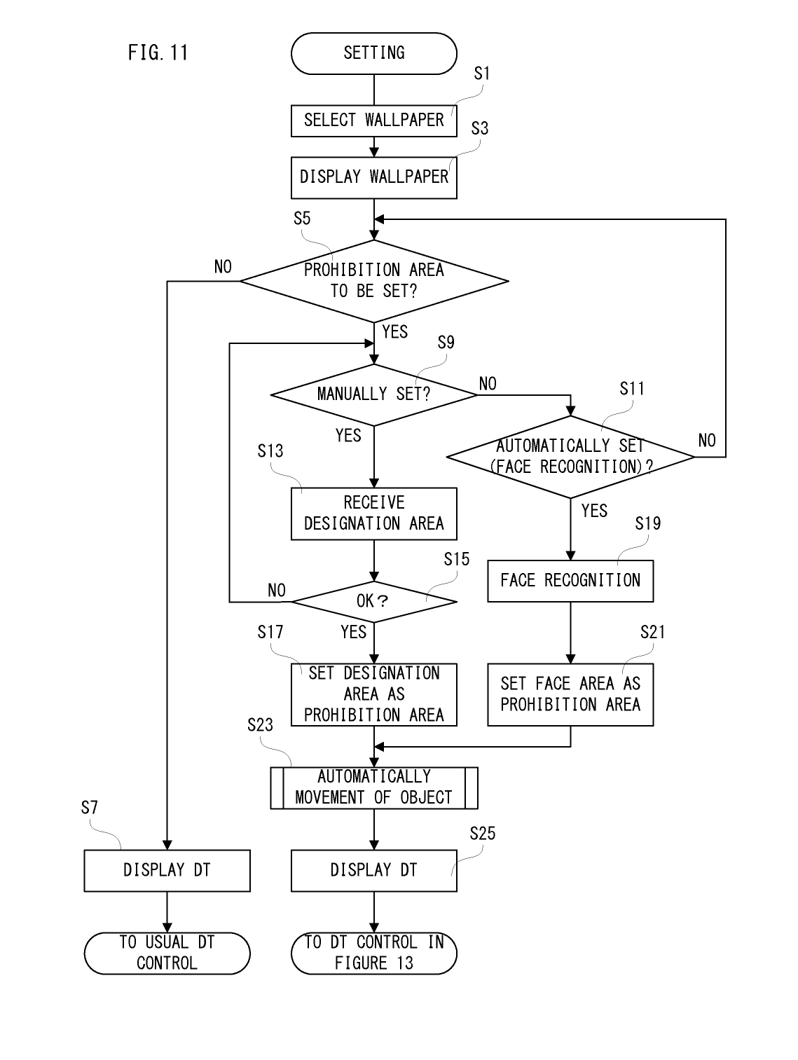

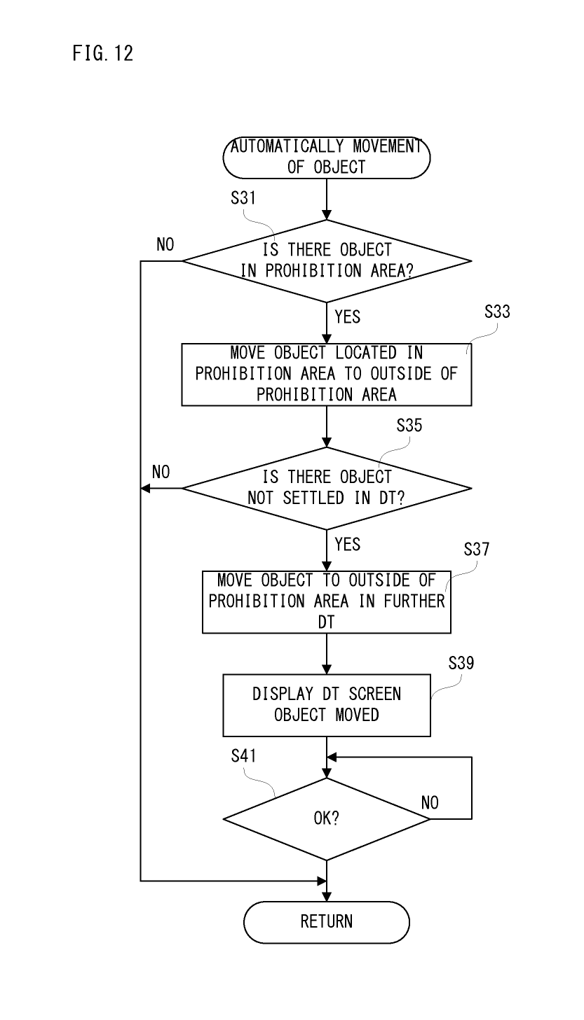

The setting of the prohibition area PA and the display control of the desktop screen DT based on the setting of the prohibition area PA as described above can be implemented by the CPU 24 that performs processing according to flowcharts shown in FIG. 11-FIG. 13 based on various kinds of programs (52-56) and data (62-72) shown in FIG. 9 and FIG. 10 that are stored in the main memory 34.

Structure of the main memory 34 is described with reference to FIG. 9. The main memory 34 includes a program area 50 and a data area 60, and the program area 50 is stored with a display control program 52, a face recognition program 54, a touch detection program 56, etc., and the data area 60 is stored with touch information 62, face area information 64, prohibition area information 66, object arrangement information 68, background image data 70, object image data 72, etc. In addition, although illustration is omitted, in the program area 50, various control programs for implementing the telephone application, the camera application, etc. described previously are also stored.

The display control program 52 is a main program for performing setting of the prohibition area PA and display control (FIG. 3-FIG. 8) of the desktop screen DT based on this, and in cooperation with the face recognition program 54 and the touch detection program 56, makes the CPU 24 perform the processing according to the flowcharts of FIG. 11-FIG. 13 while referring to the data area 60.

The face recognition program 54 is a program utilized by the display control program 52, and makes the CPU 24 perform face recognition processing (step S19 of FIG. 11) to the background image Wp. The touch detection program 56 is an auxiliary program utilized by the display control program 52, and makes the CPU 24 perform touch detection processing (not shown) based on an output of the touch panel 32.

The touch information 62 is information indicating a result of the touch detection processing, and is updated by the touch detection program 56 with a predetermined cycle (every 1/60 seconds, for example). The touch information 62 includes information indicating a touch state at present (state where nothing touches the display surface 30a, state where a hand etc. touches, and furthermore, information indicating whether during the slide operation, etc., for example), touch coordinates at present, a touch locus, etc.

The face area information 64 is information indicating a result of the face recognition processing, and is updated by the face recognition program 54 with a predetermined cycle (every 1/60 seconds, for example). Information indicating a position and size of an area (face area) that is recognized as a face image in the background images Wp is included in the face area information 64.

The prohibition area information 66 is information indicating a position and size of the prohibition area PA that is set on the display surface 30a, and is written (updated) by the display control program 52.

The object arrangement information 68 is information indicating arrangement of the object image Ob, and is written (updated) by the display control program 52. An example of a format of the object arrangement information 68 is shown in FIG. 10.

Withe referring to FIG. 10 here, this object arrangement information 68 corresponds to FIG. 6 arrangement, and includes object IDs (Ob1, Ob2, - - - , Ob14) identifying respective object images, desktop screens (DT, DT, - - -, TD2) related to the object IDs (Ob1, Ob2, - - - , Ob14), and positions ((x1, y1), (x2, y2), - - - , (x14, y14)) related to the object IDs (Ob1, Ob2, - - - , Ob14).

Returning to FIG. 9, the background image data 70 is image data for displaying the background image Wp (wallpaper) on the display surface 30a of the display 30 via the driver 28. For example, the image data of a portrait photograph photographed by the imaging device 38 or the image data of a portrait photograph acquired from the Internet via the wireless communication circuit 14 can be utilized as the background image data 70.

The object image data 72 is image data for displaying the object image Ob on the display surface 30a of the display 30 via the driver 28. The object images Ob are images displayed on the desktop screen DT such as an icon and a widget, for example.

Next, an operation of the CPU 24 based on the above-described programs and data will be described with FIG. 11-FIG. 13. If an item “Wallpaper” or “Setting prohibition area” is selected through a menu screen, the CPU 24 performs the setting processing shown in FIG. 11 under control of the display control program 52.

With reference to FIG. 11, if the setting processing is started, at first, the CPU 24 selects wallpaper based on a user operation via the touch panel 32 in a step S1. If image data of the wallpaper being selected is stored in the data area 60 of the main memory 34 as background image data 70, in a step S3, the CPU 24 applies the background image data 70 to the driver 28 to display the wallpaper on the display 30. Then, it is determined, in a step S5, whether the prohibition area PA is to be set based on the user operation. Specifically, a dialog as shown in FIG. 3(A) is displayed together with operation buttons, and if “OK” is selected, YES is determined, and if “Cancel” is selected, NO is determined.

If NO is determined in the step S5, the process proceeds to a step S7, wherein the CPU 24 displays the desktop screen DT on the display 30 by further applying the object arrangement information 68 and the object image data 72 to the driver 28. In a case of the desktop screen DT displayed in the step S7, wherein shown in FIG. 3(B), the face image included in the wallpaper (background image Wp) may be hidden by the object image Ob. Then, the CPU 24 terminates the setting processing and shifts to usual desktop control not shown.

If YES is determined in the step S5, the process proceeds to a step S9, wherein it is determined whether the prohibition area PA is to be set manually based on the user operation. Specifically, a dialog as shown in FIG. 4(A) is displayed together with operation buttons, and if “OK” is selected, YES is determined, and if “Cancel” is selected, NO is determined.

If NO is determined in the step S9, the process proceeds to a step S11, wherein it is determined whether the prohibition area PA is to be set automatically (face recognition) based on the user operation. Specifically, a dialog as shown in FIG. 5(A) is displayed together with operation buttons, and if “OK” is selected, YES is determined, and if “Cancel” is selected, NO is determined. If NO is also determined in the step S11, the process returns to the step S5 to repeat the same processing as the above.

If YES is determined in the step S9, the process proceeds to a step S13, wherein the user operation of designating an arbitrary range within the display surface 30a is received. Specifically, if the user designates an arbitrary range within the display surface 30a by a slide operation as shown in FIG. 2, for example, a locus of the slide operation is detected via the touch panel 32 under control of the touch detection program 56, and the touch information 62 indicating a detection result is written in the data area 60. Based on the start point coordinates and the end point coordinates included in the touch information 62 that is thus stored in the data area 60, the CPU 24 recognizes a rectangle that a diagonal line is made by the start point and the end point of the slide operation as shown in FIG. 2 as a range (designation range) that the user designated.

Thereafter, the process proceeds to a step S15, wherein the CPU 24 makes the user confirm whether the designation range is to be set as the prohibition area PA (is it OK). Specifically, a dialog as shown in FIG. 4(C) is displayed together with operation buttons, and if “OK” is selected, YES is determined, and if “Cancel” is selected, NO is determined. If NO is also determined in the step S15, the process returns to the step S9 to repeat the same processing as the above.

If YES is determined in the step S15, the designation range is set as the prohibition area PA. Specifically, the information indicating the designation range (for example, coordinates of the start point and the end point) is written in the data area 60 as the prohibition area information 66. Then, the process proceeds to a step S23 (described later).

If YES is determined in the step S11, the process proceeds to a step S19, wherein the face recognition processing is performed to the background image data 70 under control of the face recognition program 54. Then, a result of the face recognition processing, that is, the information (position, size, etc.) concerning the area (face area) that is recognized as a face image in the background image Wp is written in the data area 60 as the face area information 64.

Next, in a step S21, the prohibition area PA is set based on the face area information 64 that is stored in the data area 60. Specifically, an area of a circle or ellipse surrounding the face area (circumscribed to the face area) as shown in FIG. 5(B) is set as the prohibition area PA. Then, the process proceeds to a step S23.

In the step S23, object automatic moving processing (see FIG. 12) is performed based on the prohibition area information 66 and the object arrangement information 68. This object automatic moving processing is performed according to the flowchart (subroutine) of FIG. 12, for example.

Here, with reference to FIG. 12, the CPU 24 determines, at first in a step S31, whether the object image Ob exists in the inside of the prohibition area PA based on the prohibition area information 66 and the object arrangement information 68. If NO is determined in the step S31, the processing by the CPU 24 returns to the flowchart of FIG. 11.

If YES is determined in the step S31, the process proceeds to a step S33, wherein the object image Ob located in the inside of the prohibition area PA is moved to the outside of the prohibition area PA (preferably, excluding a place that another object is displayed). Next, it is determined, in a step S35, whether there is an object image Ob that cannot be settled in the desktop screen DT, and if NO is determined here, the processing of CPU 24 returns to the flowchart of FIG. 11.

If YES is determined in the step S35, the process proceeds to a step S37, wherein the object image Ob that cannot be settled in the desktop screen DT is moved to the further desktop screen DT2. Also in the further desktop screen DT2, the object image Ob is arranged outside the prohibition area PA.

Performance results of the steps S33 and S37 are reflected in the object arrangement information 68. That is, at least a part of the object arrangement information 68 is updated corresponding to the object image Ob that is moved in the steps S33 and S37.

Thereafter, the CPU 24 applies, in a step S39, the object arrangement information 68, the background image data 70 and the object image data 72 to the driver 28 to display a movement destination, that is, the further desktop screen DT2 on the display 30, and then, waits for confirmation (OK) by the user in a step S41. If an OK operation is detected by the touch panel 32 etc., YES is determined in the step S41, and the processing of CPU 24 returns to the flowchart of FIG. 11.

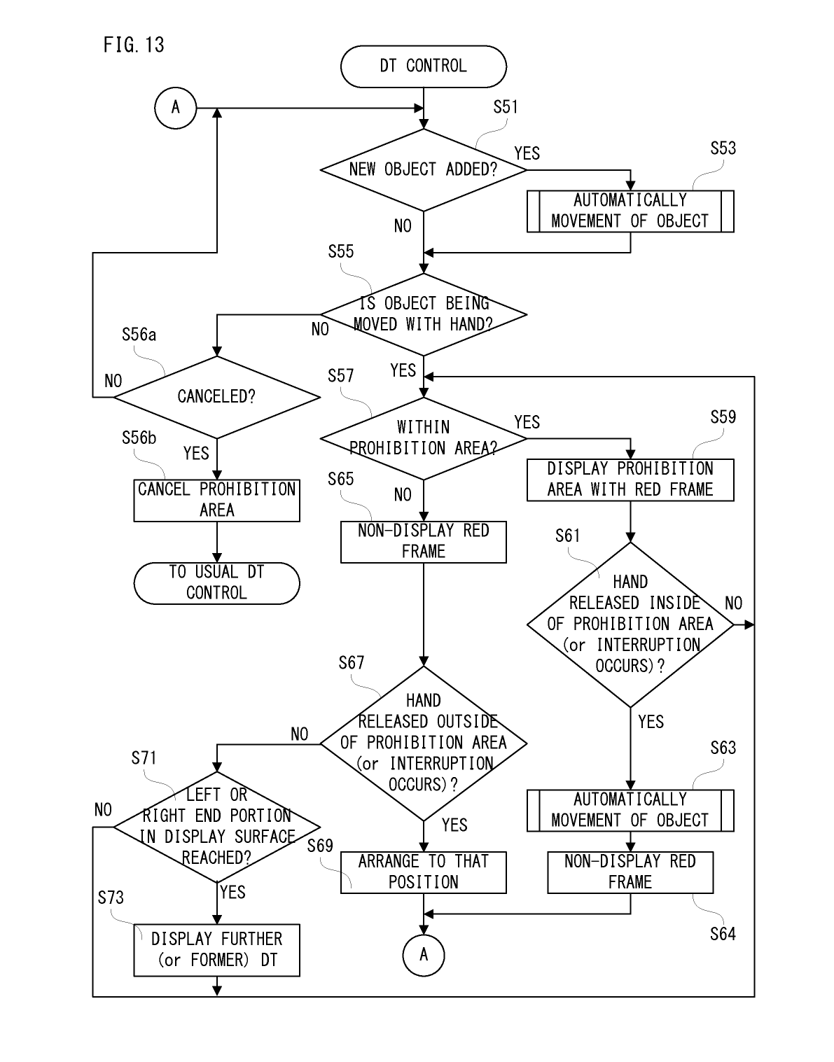

With reference to FIG. 11 again, the CPU 24 applies, in a next step S25, the object arrangement information 68, the background image data 70 and the object image data 72 to the driver 28 to display the desktop screen DT on the display 30. In a case of the desktop screen DT displayed in the step S25, as shown in FIG. 4(D) and FIG. 5(B), for example, since the prohibition area PA is set to the display surface 30a, the face image becomes not to be hidden by the object image Ob. Then, the processing of the CPU 24 proceeds to desktop control of FIG. 13.

Next, with reference to FIG. 13, if the desktop control processing is started, at first, the CPU 24 determines, in a step S51, whether a new object image Ob is added based on the object arrangement information 68 etc. For example, when new application software (application) is installed, arrangement information and image data of the new object image Ob(s) (icon etc.) corresponding to the new application are added to the object arrangement information 68 and the object image data 72, respectively, and the new object image Ob appears in the desktop screen DT, and therefore, it can be determined based on the object arrangement information 68 (and/or object image data 72) whether the new object image Ob is added.

If NO is determined in the step S51, the process proceeds to a step S55. If YES is determined in the step S51, the process proceeds to a step S55 after performing the object automatic moving processing (see FIG. 11: described above) in a step S53.

It is determined, in the step S55, whether the object image Ob is being moved by hand based on the touch information 62 and the object arrangement information 68. If NO is determined in the step S55, the process proceeds to a step S56a, wherein it is determined, based on the user operation, whether the prohibition area that is set in the step S17 or S21 is to be canceled. For example, a cancel button not shown is always displayed on the desktop screen DT, and if the touch operation to this cancel button is detected, YES is determined, and if not detected, NO is determined.

If NO is determined in the step S56a, the process returns to the step S51 to repeat the same processing as the above. In addition, the loop processing that returns from the step S51 to the step S51 through the steps S55 and S56a is performed with a cycle of 1/60 seconds, for example.

If YES is determined in the step S56a, the process proceeds to a step S56b, wherein the prohibition area that is set in the step S17 or S21 is canceled. Then, the processing of the CPU 24 shifts to the usual desktop control not shown.

If YES is determined in the step S55, the process proceeds to a step S57, wherein it is determined whether the position of the object image Ob that is being moved is in the inside of the prohibition area PA based on the prohibition area information 66 and object arrangement information 68.

If YES is determined in the step S57, the CPU 24 displays, in a step S59, the prohibition area PA on the display 30 with a red frame via the driver 28. In addition, other colors such as blue may be sufficient as a color of the frame, or without displaying the frame itself and an inside (or outside) of the frame may be colored, or brightness of the inside (or outside) of the frame may be changed.

In a next step S61, it is determined whether the user releases the hand within the inside of the prohibition area PA (or the interruption such as arrival etc. occurs) based on the touch information 62 etc., and if NO is determined here, the process returns to the step S57 to repeat the same processing as the above.

If YES is determined in the step S61, by performing the object automatic moving processing (see FIG. 11: described above) in a step S63, the object image Ob, that is, the object image Ob that is released in the inside of the prohibition area PA (or movement is interrupted in the inside of the prohibition area PA by interruption) is forcedly moved to the outside of the prohibition area PA. Then, after non-displaying the red frame in a step S64, the process returns to step the S51 to repeat the same processing as the above.

If NO is determined in the step S57, after non-displaying the red frame in a step S65 (in addition, when the red frame is not displayed, this step S65 may be skipped), the process proceeds to a step S67, wherein it is determined whether the user releases the hand in the outside of the prohibition area PA based on the touch information 62 etc. (or the interruption such as arrival etc. occurs), and if YES is determined here, after arranging the object image Ob in that position, that is, a position that the hand is released (or at the time of arrival occurring) in a step S69, the process returns to the step S51 to repeat the same processing as the above.

If YES is determined in the step S67, it is further determined, in a step S71, whether the object image Ob reaches the left end portion or right end portion of the display surface 30a (see FIG. 8(A)) based on the object arrangement information 68, and if NO is determined here, the process returns to the step S57 to repeat the same processing as the above.

If YES is determined in the step S71, the CPU 24 displays the further desktop screen DT2 on the display 30 via the driver 28 in a step S73 (see FIG. 8(B)). In addition, when the displaying at present is the further desktop screen DT2, the CPU 24 displays a still further desktop screen DT3 (not shown) or the former desktop screen DT. Then, the process returns to step the S57 to repeat the same processing as the above.

It is clearly understood from the above, in this embodiment, the CPU 24 of the portable terminal 10 sets (S17, S21) the prohibition area PA to the display surface 30a when the object image Ob is to be displayed on the display surface 30a to be arranged on the background image Wp, moves (S23, S53, S63) the object image OB located in the inside of the prohibition area PA is moved to the outside of the prohibition area PA, and displays (S25) on the display surface 30a the desktop screen DT that the object image Ob after movement is arranged on the background image Wp. Therefore, the object can be displayed while avoiding a desired portion.

Furthermore, the CPU 24 makes the display surface 30a display the background image Wp before setting of the prohibition area PA (S3). By thus displaying the background image Wp in advance, the user can designate the prohibition area PA suitable for the background image Wp.

Furthermore, when the prohibition area PA is set, the CPU 24 determines the existence of the object image Ob located in the inside of the prohibition area PA, and when there is the object image Ob located in the inside of the prohibition area PA, moves that object image Ob to the outside of the prohibition area PA (S31: YES to S33). Accordingly, if the user designates a desired portion of the background image Wp, that portion is set as the prohibition area PA, and as a result of moving the object image Ob located in the inside of the prohibition area PA that is set to the outside, the object can be displayed while avoiding the desired portion.

Here, the display surface 30a is a display surface of a touch device (for example, the display 30 that the touch panel 32 is provided), and the CPU 24 sets the prohibition area based on the position information detected by the touch device (S17). Therefore, in the portable terminal 10, it is possible to set the prohibition area manually.

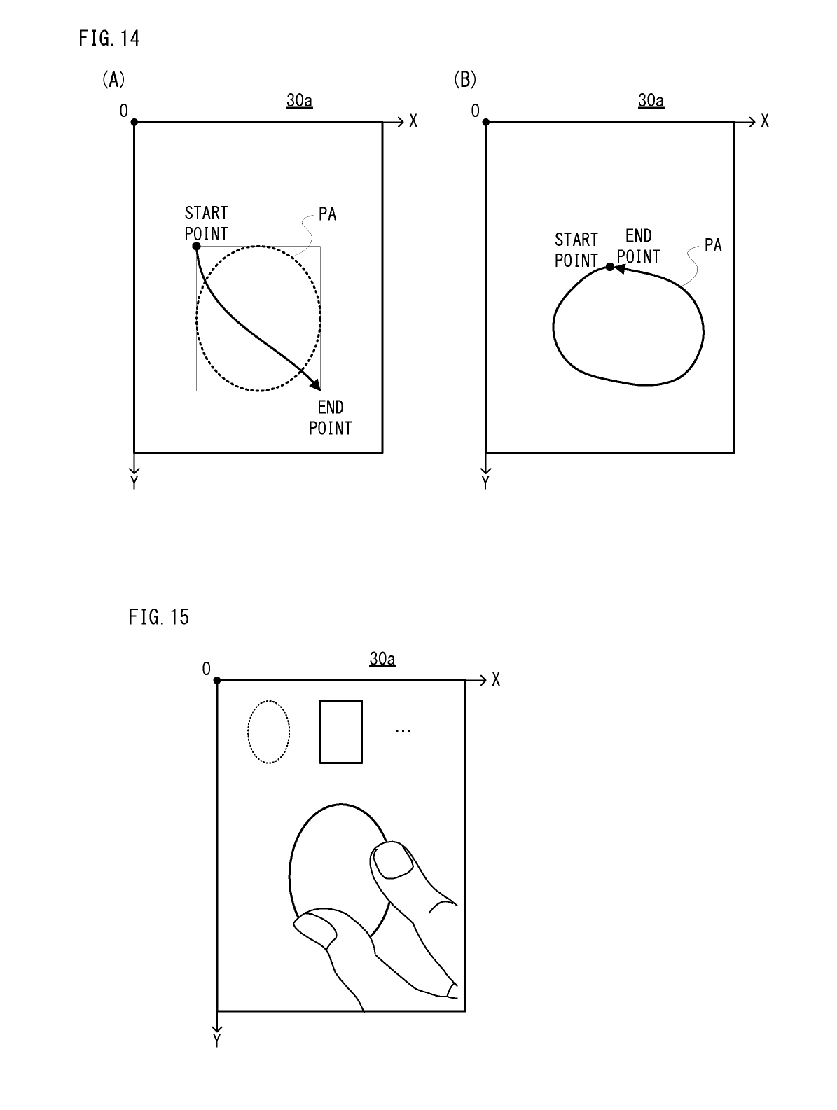

When the manual setting is selected, the CPU 24 sets a range defined by the start point and the end point of the slide operation that is detected by the touch device, and more specifically, a range of a rectangle that a diagonal line is made by the start point and the end point of the slide operation is set as the prohibition area PA (FIG. 2, FIG. 4(A)). In an modified example, an area inscribed in such a rectangle may be set as the prohibition area PA (FIG. 14(A)). Otherwise, a circular area that the start point is made a center and a radius is made from the start point to the end point may be set as the prohibition area PA (not shown). In a further modified example, a range surrounded by the locus of the slide operation may be set as the prohibition area PA (FIG. 14(B)). Thus, the prohibition area PA can be set by the slide operation.

In other embodiments, templates are displayed on the display surface 30a of the touch device, and the prohibition area PA corresponding to the template that is selected by the touch device may be set (FIG. 15).

Furthermore, it is possible to select setting the prohibition area PA automatically in the portable terminal 10, and if the automatic setting (face recognition) is selected, the CPU 24 performs the face recognition to the background image Wp (S19), and sets the prohibition area based on a recognition result (S21). Accordingly, it is possible to set the prohibition area PA automatically, and to display the object with avoiding a portion of a face. In addition, in a modified example, edge detection may be performed to the background image Wp, and the prohibition area PA may be set based on a result of the edge detection.

Furthermore, the CPU 24 moves the object image Ob to the further desktop screen DT2 in a case where there is the object image Ob that cannot be settled in the portion except the prohibition area PA of the desktop screen DT (S35: YES to S37). Therefore, even if the object that cannot be settled in the desktop screen DT occurs by setting of the prohibition area PA, since the object is moved to the further desktop screen DT2, it is possible to prevent the object that cannot be settled in the desktop screen DT from becoming not to be displayed.

Here, the further desktop screen DT2 is a screen that the object that cannot be settled in a portion excluding the prohibition area PA of the desktop screen DT is arranged together with an image that is the same as the background image Wp, and the CPU 24 moves the object image Ob that cannot be settled in the desktop screen DT to a portion excluding the prohibition area PA of the further desktop screen DT2 (FIG. 6(B)). Since the object image Ob is thus arranged to avoid the prohibition area PA even in the further desktop screen DT2, if the same background image Wp is used, it is possible to display the object with avoiding a desired portion.

Furthermore, the CPU 24 temporarily displays a movement destination, that is, the further desktop screen DT2 , after moving the object to the further desktop screen DT2 (S39). Accordingly, it is possible to prevent the user from missing the object image Ob that is moved to the further desktop screen DT2.

Furthermore, when a new object image Ob is added, the CPU 24 determines the existence of an object image Ob located in the inside of the prohibition area PA, and in a case where there is the object image Ob located in the inside of the prohibition area PA, moves the object image Ob to the outside of the prohibition area PA (S31: YES to S33). Therefore, since the movement from the inside of the prohibition area PA to the outside thereof is performed also when a new object image Ob is added, the object can be displayed while avoiding a desired portion.

Furthermore, the CPU 24 moves the object image Ob that is displayed on the display surface 30a based on the position information detected by the touch device (S55), and in a case where the object image Ob that is thus being moved by hand enters into the inside of the prohibition area PA, displays the prohibition area PA (S57: YES to S59). Accordingly, it is possible to warn not to be arranged inside the prohibition area by hand.

Furthermore, in a case where the object image Ob is arranged by hand in the inside of the prohibition area PA (S61: YES), the CPU 24 moves the object image Ob to the outside of the prohibition area PA (S31: YES to S33). Therefore, even if the object image Ob is manually arranged in the inside of the prohibition area PA, since the object image Ob is automatically moved to the outside of the prohibition area PA, the object can be displayed while avoiding a desired portion.

Furthermore, in a case where the object image Ob is moved by hand to the end portion of the desktop screen DT, the CPU 24 displays on the display surface 30a the further desktop screen DT2 that the object image Ob is arranged on the same image as the background image Wp (S71: YES to S73). Therefore, since the same kind of further desktop screen DT2 becomes to be displayed if the object image Ob reaches the end portion of the desktop screen DT, a moving range by a hand can be expanded.

Furthermore, the CPU 24 cancels the prohibition area PA if a cancellation operation is performed after setting of the prohibition area PA (S56b). In addition, even if the prohibition area PA is canceled, the CPU 24 does not perform processing that the object image Ob moved to the outside of the prohibition area PA is returned to the inside of the prohibition area PA. By thus canceling the prohibition area PA, it becomes possible to display an object in a portion corresponding to the prohibition area after it.

Although the display of the display surface 30a is changed to the further desktop screen DT2 in this embodiment in a case where the object image Ob cannot be arranged in the desktop screen DT or in a case where the object image Ob that is being moved by hand reaches the left end portion or the right end portion of the display surface 30a, in other embodiments, it may be constructed that the background image Wp that is a larger size than the display surface 30a is stored and a part thereof is displayed on the display surface 30a, the control that makes the displaying of the background image Wp scroll in a case where the object image Ob cannot be arranged in the desktop screen DT or in a case where the object image Ob that is being moved by hand reaches the left end portion or the right end portion of the display surface 30a may be performed.

In addition, although a form or shape of the prohibition area PA is a rectangle, a circle or an ellipse in the embodiment, a polygon such as a hexagon etc. may be sufficient, and further, as long as all or most of a desired portion (for example, face area) is included, in general, an arbitrary form or shape may be sufficient.

In addition, the prohibition area PA is set on the display surface 30a (as a result, that is common to all the desktop screens DT, DT2, - - - ) in the embodiment, in other embodiments, the prohibition area may be set for each desktop screen. In such a case, since the prohibition area PA differs for each desktop screen, and different wallpaper may be used for each desktop screen.

Furthermore, in a case where an image A is set as a wallpaper, and an image B is subsequently set as a wallpaper, and then, the image A is set as the wallpaper again, for example, the setting of the prohibition area PA may be recorded in relation to the image A such that it is not necessary for the user to perform the setting of the prohibition area PA to the image A again. Then, in a case where the image A is set as wallpaper again, a confirmation screen whether the former setting of the prohibition area PA is to be utilized is displayed, and if it is OK, the user can set the prohibition area PA that is previously set as the prohibition area PA to the wallpaper again.

In addition, in a case where the prohibition area PA is to be set manually, although the user designates the rectangular range by the slide operation in the embodiment, in a modified example, the user may designate a range of a circular or elliptical shape by a slide operation. In such a case, the CPU 24 can set an inside of a circle or ellipse inscribed in the rectangle that is defined by the start point and the end point of the slide operation as the prohibition area PA, as shown in FIG. 14(A). Otherwise, an inside of a circular area that the start point is made a center and a radius is made from the start point to the end point may be set as the prohibition area PA.

In a further modified example, as shown in FIG. 14(B), for example, the user may draw an area such as a circle or a rectangle by the slide operation, and the CPU 24 may set an area surrounded by the locus of the slide operation as the prohibition area PA.

Although the manual setting in the embodiments and modified examples is performed using the locus of the slide operation (that is, in a handwritten manner), in other embodiments, the setting may be performed using a template. For example, the CPU 24 displays a plurality of templates that show various kinds of figures such as an ellipse and a rectangle on the display surface 30a as shown in FIG. 15, and if one template of them is moved to an arbitrary position based on the slide operation detected by the touch panel 32 and the template is further made to expand and contract based on the touch operation, the user can set a desired prohibition area PA manually.

Furthermore, in a case where the prohibition area PA is to be set automatically, the face recognition is used in the embodiment, but in a modified example, edge detection may be used. Specifically, the CPU 24 detects an edge (outline) from the background image Wp based on image information such as color difference and a brightness difference, and sets the prohibition area PA based on arrangement and density of the edge that is detected. For example, an object included in the background image Wp is presumed by comparing the edge arrangement being detected with the edge arrangement being registered in the database, and when a presumed result is a specific object (for example, a person, animals and plants, car body, etc.), there is a method of setting the prohibition area PA to surround the object, a method that an area that the edge density being detected is high in comparison with the circumference is set as the prohibition area PA, etc.

Although the portable terminal 10 is described above, the present invention can be applied to a display control apparatus (for example, a smartphone, a tablet PC, various kinds of information terminals) that displays on the display surface of a touch device (for example, a touch panel or a display with a touch screen) by arranging an object image (for example, an icon, a widget) on a background image (for example, photograph images such as a person, animals and plants, and a vehicle).

In general, the following structure may be adopted as forms for embodying the present invention. It should be noted that reference numerals inside the parentheses, the supplements, etc. show corresponding relationships with the embodiments described above for easy understanding of the invention, and do not limit the invention.

A first form of the invention is a display control apparatus that displays an object image on a display surface to be arranged on a background image, comprising: a setting module operable to set a prohibition area in the display surface; a first moving module operable to move the object image located in an inside of the prohibition area that is set by the setting module to an outside of the prohibition area; and a control module operable to display on the display surface a screen that the object image after moved by the first moving module is arranged on the background image.

In the first form, in the display control apparatus (10) that arranges an object image (Ob) on a background image (Wp) to display on the display surface (30a), by performing by the CPU (24) a display control program (52), for example, the setting module, the first moving module and the control module are implemented. The setting module is operable to set the prohibition area (PA) to the display surface (S17, S21), and the first moving module is operable to move the object image located in the inside of the prohibition area that is set by the setting module to the outside of the prohibition area (S23, S53, S63), and the control module is operable to display on the display surface the screen (DT) that the object image after movement by the first moving module is arranged on the background image (S25).

According to the first form, since the object located in the inside of the prohibition area is moved to the outside of the prohibition area, while setting the prohibition area to the display surface, the object can be displayed while avoiding a desired portion.

A second form is according to the first form, and further comprises a background display module (S3) operable to display a background image on the display surface before setting by the setting module.

According to the second form, a user can designate the prohibition area suitable for the background image by displaying the background image in advance.

A third form is according to the second form, wherein the first moving module (S23) is operable to determine existence of an object image located in the inside of the prohibition area when the prohibition area is set by the setting module, and if there is an object image located in the inside of the prohibition area, move the object image to the outside of the prohibition area (S31: YES to S33).

According to the third form, if a user designates a desired portion in the background image, the portion is set as the prohibition area, and as a result of moving the object image located in the inside of the prohibition area to the outside, the object can be displayed while avoiding the desired portion.

A fourth form is according to the second form, wherein the display surface is a display surface of a touch device (30, 32), and the setting module is operable to set the prohibition area based on position information detected by the touch device (S17).

According to the fourth form, the prohibition area can be set manually.

A fifth form is according to the fourth form, wherein the setting module is operable to set a range that is defined by a start point and an end point of a slide operation that is detected by the touch device as the prohibition area.

According to the fifth form, the prohibition area can be set by a slide operation.

In addition, although a setting module sets a rectangular area that a diagonal line is made by the start point and the end point as the prohibition area (FIG. 2, FIG. 4(A)) in a certain embodiment, an area inscribed in such a rectangle may be set as the prohibition area (FIG. 14(A)) in a modified example. Otherwise, a circular area that the start point is made a center and a radius is made from the start point to the end point may be set as the prohibition area. In other modified examples, the setting module may set a range surrounded by a locus of the slide operation as the prohibition area (FIG. 14(B)).

In another embodiment, a displaying module displays templates on a display surface of a touch device, and the setting module may set the prohibition area PA corresponding to the template that is selected by the touch device (FIG. 15).

A sixth form is according to the first form, and further comprises a face recognition module (S19) operable to perform a face recognition to a background image, wherein the setting module is operable to set the prohibition area based on a recognition result of the face recognition module (S21).

According to the sixth form, by utilizing the face recognition, the prohibition area can be set automatically, and the object can be displayed while avoiding a portion of a face.

In addition, edge detection may be performed to the background image, and the prohibition area may be set based on a result of the edge detection.

A seventh form is according to the first form, wherein when there is an object image that cannot be settled in a portion excluding the prohibition area of a screen (S35: YES to S37), the first moving module is operable to move the object image to a further screen (DT2).

According to the seventh form, even if the object that cannot be settled in the screen exists because of setting of the prohibition area, it is possible to prevent the object (Ob) that cannot be settled in a desktop screen (DT) from not being displayed by moving the object to the further screen.

An eighth form is according to the seventh form, wherein the further screen is a screen that the object that cannot be settled in a portion excluding the prohibition area of the screen on the same image as the background image, and the first moving module is operable to move the object image that cannot be settled in the screen to a portion excluding the prohibition area of the further screen (FIG. 6(B)).

According to the eighth form, since the object image is arranged to avoid the prohibition area also in the further screen, if the same background image is used, the object can be displayed while avoiding a desired portion.

A ninth form is according to the seventh form, wherein the control module is operable to temporarily display the further screen after moving to the further screen (DT2) by the first moving module (S39).

According to the ninth form, it is possible to prevent a user from missing the object image that is moved to the further screen.

A tenth form is according to the second form, wherein the first moving module (S53) is operable to determine, when a new object image is added, existence of an object image located in the inside of the prohibition area, and when there is an object image located in the inside of the prohibition area, move the object image to the outside of the prohibition area (S31: YES to S33).

According to the tenth form, since a movement to the outside from the inside of the prohibition area is performed, even when a new object image is added, it is possible to display the object with avoiding a desired portion.

An eleventh form is according to the second form, and further comprises a second moving module (S55) operable to move the object image displayed on the display surface based on position information detected by the touch device, wherein the control module is operable to display the prohibition area when the object image that is being moved by the second moving module enters into the inside of the prohibition area (S57: YES to S59).

According to the eleventh form, since the prohibition area is displayed when the object image that is being moved enters into the inside of the prohibition area, it is possible to warn that an object image is not arranged in the inside of the prohibition area.

A twelfth form is according to the eleventh form, wherein the first moving module (S63) is operable to move the object image to the outside of the prohibition area when the object image is arranged by the second moving module in the inside of the prohibition area (S61: YES) (S31: YES to S33).

According to the twelfth form, even if the object image is manually arranged into the inside of the prohibition area, since the object image is automatically moved to the outside of the prohibition area, the object image can be displayed while avoiding a desired portion.

A thirteenth form is according to the eleventh form, wherein the control module is operable to display, when an object image is moved to an end portion of a screen by the second moving module, a further screen (DT2) that the object image is arranged on the same image as the background image on the display surface (S71: YES to S73).

According to the thirteenth form, since the further screen of the same kind is displayed if the object image is moved to the end portion of the screen by hand, a moving range by hand can be expanded.

A fourteenth form is according to the first form, and further comprises a cancellation module (S56b) operable to cancel the prohibition area that is set by the setting module.

Preferably, even if the prohibition area that is set by the setting module is canceled by the cancellation module, the processing for returning the object that is moved to the outside of the prohibition area by the moving module to the inside of a prohibition area is not performed.

According to the fourteenth form, if canceling the prohibition area, the object now becomes to be displayed in a portion corresponding to the prohibition area after it.

A fifteenth form is a display control program (52) that causes a CPU (24) of a display control apparatus (10) that displays an object image (Ob) on a display surface (30a) to be arranged on a background image (Wp) to function as: a setting module (S17, S21) operable to set a prohibition area (PA) in the display surface; a first moving module (S23, S53, S63) operable to move the object image located in an inside of the prohibition area that is set by the setting module to an outside of the prohibition area; and a control module (S25) operable to display on the display surface a screen (DT) that the object image after moved by the first moving module is arranged on the background image.

A sixteenth form is a display control method in a display control apparatus (10) that displays an object image (Ob) on a display surface (30a) to be arranged on a background image (Wp), comprising steps of: a setting step (S17, S21) setting a prohibition area (PA) in the display surface; a first moving step (S23, S53, S63) moving the object image located in an inside of the prohibition area that is set by the setting step to an outside of the prohibition area; and a control step (S25) displaying on the display surface a screen (DT) that the object image after moved by the first moving step is arranged on the background image.

According to also the fifteenth or sixteenth form, like the first form, the object can be displayed while avoiding a desired portion.

Although the present invention has been described and illustrated in detail, it is clearly understood that the same is by way of illustration and example only and is not to be taken by way of limitation, the spirit and scope of the present invention being limited only by the terms of the appended claims.

### Description of Numerals

10 - - - portable terminal
24 - - - CPU
28 - - - driver
30 - - - display
30a - - - display surface
32 - - - touch panel
34 - - - main memory
DT, DT2 - - - desktop screen
Ob - - - object image
PA - - - prohibition area
Wp - - - background image (wallpaper)

1. A display control apparatus that displays an object image on a display surface to be arranged on a background image, comprising:
a setting module operable to set a prohibition area in the display surface;
a first moving module operable to move the object image located in an inside of the prohibition area that is set by the setting module to an outside of the prohibition area; and
a control module operable to display on the display surface a screen that the object image after moved by the first moving module is arranged on the background image.

2. The display control apparatus according to claim 1, further comprising a background display module operable to display the background image on the display surface before setting by the setting module.

3. The display control apparatus according to claim 2, wherein the first moving module is operable to determine existence of an object image located in the inside of the prohibition area when the prohibition area is set by the setting module, and if there is an object image located in the inside of the prohibition area, move the object image to the outside of the prohibition area.

4. The display control apparatus according to claim 2, wherein the display surface is a display surface of a touch device, and
the setting module is operable to set the prohibition area based on position information detected by the touch device.

5. The display control apparatus according to claim 4, wherein the setting module is operable to set a range that is defined by a start point and an end point of a slide operation that is detected by the touch device as the prohibition area.

6. The display control apparatus according to claim 1, further comprising a face recognition module operable to perform a face recognition to a background image,
wherein the setting module is operable to set the prohibition area based on a recognition result of the face recognition module.

7. The display control apparatus according to claim 1, wherein when there is an object image that cannot be settled in a portion excluding the prohibition area of a screen, the first moving module is operable to move the object image to a further screen.

8. The display control apparatus according to claim 7, wherein the further screen is a screen that the object that cannot be settled in a portion excluding the prohibition area of the screen on the same image as the background image, and
the first moving module is operable to move the object image that cannot be settled in the screen to a portion excluding the prohibition area of the further screen.

9. The display control apparatus according to claim 7, wherein the control module is operable to temporarily display the further screen after moving to the further screen by the first moving module.

10. The display control apparatus according to claim 2, wherein the first moving module is operable to determine, when a new object image is added, existence of an object image located in the inside of the prohibition area, and when there is an object image located in the inside of the prohibition area, move the object image to the outside of the prohibition area.

11. The display control apparatus according to claim 2, further comprising a second moving module operable to move the object image displayed on the display surface based on position information detected by the touch device,
wherein the control module is operable to display the prohibition area when the object image that is being moved by the second moving module enters into the inside of the prohibition area.

12. The display control apparatus according to claim 11, wherein the first moving module is operable to move the object image to the outside of the prohibition area when the object image is arranged by the second moving module in the inside of the prohibition area.

13. The display control apparatus according to claim 11, wherein the control module is operable to display, when an object image is moved to an end portion of a screen by the second moving module, a further screen that the object image is arranged on the same image as the background image on the display surface.

14. The display control apparatus according to claim 1, further comprising a cancellation module operable to cancel the prohibition area that is set by the setting module.

15. A display control program that causes a CPU of a display control apparatus that displays an object image on a display surface to be arranged on a background image to function as:
a setting module operable to set a prohibition area in the display surface;
a first moving module operable to move the object image located in an inside of the prohibition area that is set by the setting module to an outside of the prohibition area; and
a control module operable to display on the display surface a screen that the object image after moved by the first moving module is arranged on the background image.

16. A display control method in a display control apparatus that displays an object image on a display surface to be arranged on a background image, comprising steps of:
a setting step setting a prohibition area in the display surface;
a first moving step moving the object image located in an inside of the prohibition area that is set by the setting step to an outside of the prohibition area; and
a control step displaying on the display surface a screen that the object image after moved by the first moving step is arranged on the background image.
